(19) United States
(12) Patent Application Publication
(10) Pub. No.: US 2010/0201137 A1
(43) Pub. Date: Aug. 12, 2010

(54) ADVANCED HANDLE SQUARE FOR ANY OPENING MEMBER

(76) Inventor: Bertrand Wartel, Nucourt (FR)

Correspondence Address: FULBRIGHT & JAWORSKI, LLP, 666 FIFTH AVE, NEW YORK, NY, 10103-3198, US

(21) Appl. No.: 12/599,628

(22) PCT Filed: Apr. 29, 2008
(86) PCT No.: PCT/FR08/50771

§ 371 Date: Feb. 22, 2010

(51) Int. Cl. E05B 1/00

(52) U.S. Cl. 292/336.3

(57) ABSTRACT

The lack of adaptation of various models developed for satisfying a need for an efficient door handle safety system, especially for children, has been clearly assessed. In order to solve this problem, according to the invention and instead of using a low-safety and inconvenient lock, the handle is simply disassembled in order to replace the existing square with the advanced square of the present invention. The square includes a threaded portion and a tapped portion. One side of the door is secured, which is useful for basement rooms, while the other side operates in a traditional manner. In order to actuate the bolt the lever handle must first be raised in order to momentarily block the two portions of the square relative to each other. It is then possible to actuate the bolt by lowering the lever handle and unlocking the latter by applying, in a second time, a force having an amplitude higher than that required for the opening.

This invention relates to an advanced handle square for a door, window, or any other opening member.

A door handle includes a housing that contains a mechanism for controlling a locking or unlocking to open or close the opening. Today, a handle is also equipped with a return element for keeping the lever handle in a horizontal position.

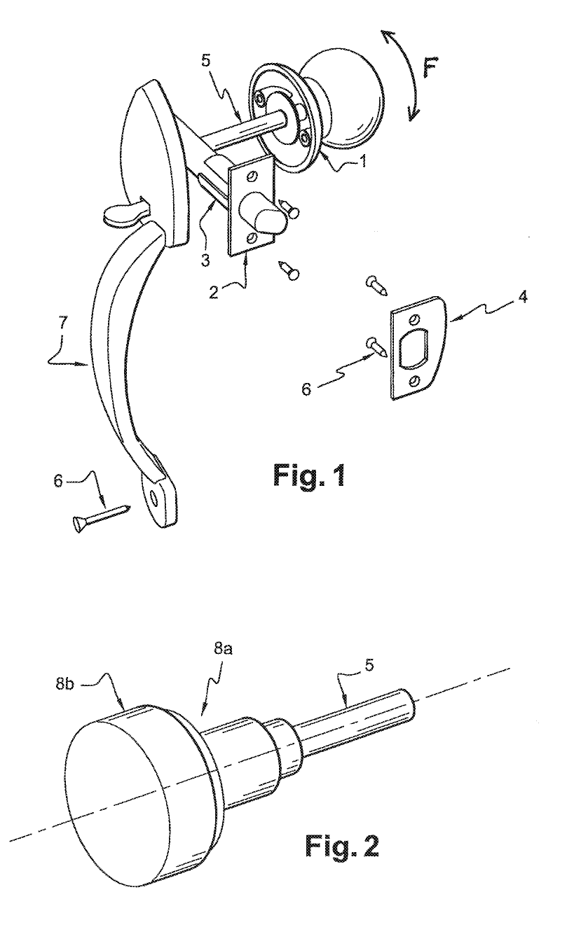

FIG. 1 represents an example door handle system according to prior art. The system comprises:
a knob 1 to be grasped by a user's hand and subjected to a rotative force F,
a mechanism for controlling a locking or unlocking to open or close the door, comprising a latch bolt 2 positioned within the door and sliding along a side 3, a strike plate 4 positioned on the door jamb, facing the bolt 2, and a follower,
a square 5 at least partially crossing the opening and transferring said force to said housing,
assembly screws 6,
an exterior handle 7.

As a reminder, a lock's follower is usually partly brass, square shaped, and the approximate length of the door's width, which operates the latch lock. A lever handle or knob placed on the follower allows the lock to be maneuvered, via the square, when it is not closed with a key.

In the prior art, most handles also have a return spring so that the lever handle rests in a horizontal position when it is not being used and a stopping mechanism that limits the lever handle's angle of rotation to about 90°.

The mechanical properties of the square 5 are as follows:

24 daN/mm²≦Re≦100 daN/mm² where Re is an elastic resistance corresponding to a penetration hardness. The measurement principle is always the same; an undeformable indenter leaves an impression in the material being tested. Hardness is measured from the dimensions of the impression. In a first approach, the Re elastic resistance limit can be quite simply linked to the surface of the impression. The more the penetrating object pushes in, the larger the contact surface S and, with the force F being constant, the less the stress. When the stress is no longer sufficient to plastically deform the solid being tested, the penetrating object stops, and we have: Re=RS.

In this area, parents know that doors do not stop young children. To prevent doors from being opened unexpectedly, parents may lift the level handle to a vertical position, an improvised solution that, if it works, is no less penalizing for the parents and the safety of their children.

In the prior art, there is also a spring mechanism located inside of a knob handle, as shown in FIG. 2. This mechanism allows the knob 8a to be maneuvered only after sliding a cap 8b associated with the knob 8a. This sliding action requires a force of around 30 newtons, which is equivalent to living three kilograms. In all cases, this mechanism necessarily involves a change to at least a knob. The operation then requires said mechanism to be installed on the square 5 serving as a shaft for the handle.

The lack of adaptation of various models developed here for satisfying a need for an efficient door handle safety system has been clearly assessed.

In order to solve this problem, according to the invention and instead of using a low-safety lock, the handle is simply disassembled in order to replace the existing square with the advanced square of the present invention. The square includes a threaded portion and a tapped portion.

One side of the door is secured, which is useful for basement rooms or garages, while the other side operates in a traditional manner.

In order to actuate the latch bolt, the lever handle must first be raised in order to momentarily lock, by friction, the two portions of the shaft relative to each other. It is then possible to actuate the mechanism by lowering the level handle. Once the mechanism has been actuated and the door opened, by continuing to lower the lever handle with a force greater than what is required to open it, both parts of the square are unlocked, the friction no longer being sufficient.

Generally, handles are equipped with a return spring in the plates. With the invention, this return is useless in terms of safety. In one variant of the invention, the advanced square has an elastic means for keeping the lever handle in a predetermined resting position. This resting position generally corresponds to a horizontal position.

This invention therefore relates to an advanced handle square for a door, window, or any other opening member, the square
coordinating with a mechanical housing that contains a follower to actuate a bolt that controls a locking or unlocking to open or close the opening,
coordinating with at least one lever handle designed to be actuated by a user's hand,
at least partially crossing the opening and transferring a force to said housing,
being comprised of two distinct parts and capable of coordinating with one another, one being threaded and the other being tapped,

characterized in that
both parts are assembled by screwing with at least one washer between them, and locked in relation to one another by friction from both on the washer,
this friction being achieved by turning the lever handle in an opposite direction of an action to open the opening,
this friction being released for unlocking by a rotational movement of the lever handle in a direction corresponding to an opening action, but such that the unlocking force is greater than the force required to open it, and is exercised beyond the opening.

In one variant, the invention relates to an advanced handle square for a door, window, or any other opening member, the square
coordinating with a mechanical housing that contains a follower to actuate a bolt that controls a locking or unlocking to open or close the opening,
coordinating with at least one lever handle designed to be actuated by a user's hand,
at least partially crossing the opening and transferring a force to said housing,
being comprised of three distinct parts and capable of coordinating with one another, two being tapped and the other being double threaded,

characterized in that
the three parts are assembled by screwing with two washers between them, and locked in relation to one another by friction from all three on the washers,
this friction being achieved by turning the lever handle in an opposite direction of an action to open the opening,
this friction being released for unlocking by a rotational movement of the lever handle in a direction corresponding to an opening action, but such that the unlocking force is greater than the force required to open it, and is exercised beyond the opening.

In one variant, the square according to the invention is also characterized in that the stopping of the two parts to control the unlocking of the opening requires a force and psychomotricity greater than that of a young child.

In one variant, the square according to the invention is also characterized in that one side of the washer abuts the follower.

In one variant, the square according to the invention is also characterized in that the assembly washer is an elastic Belleville washer.

In one variant, the square according to the invention is also characterized in that the part that includes the tapping, whose length is greater than the part that includes the threading, coordinates with the follower.

In one variant, the square according to the invention is also characterized in that the threading is obtained by machining the material.

In one variant, the square according to the invention is also characterized in that the threading is obtained by screwing and by the thermal, or mechanical, or chemical, fixing of a headless screw within the shortest part of the square.

In one variant, the square according to the invention is also characterized in that it includes an elastic mechanism to allow the lever handle to rest in a horizontal position when it is not actuated.

In one variant, the square according to the invention is also characterized in that the elastic mechanism is a torsion spring positioned at the bottom of the tapping and connecting the two parts.

In one variant, the square according to the invention is also characterized in that the mechanical properties of the square's material are as follows:

24 daN/mm²≦Re≦100 daN/mm² where Re is the material's elastic resistance.

In one variant, the square according to the invention is also characterized in that the square is made from an aluminum alloy between series 1000 and series 7000.

In one variant, the square according to the invention is also characterized in that the square has a section of between 5 and 10 millimeters.

In one variant, the square according to the invention is also characterized in that the pitch of the screw threading and tapping is calculated such that the locking rotation stops in a predetermined position of the lever handle.

In one variant, the square according to the invention is also characterized in that the length of the threading and tapping represents at least 5% of the total length of the square, but it is less than the thickness of the door.

In one variant, the square according to the invention is also characterized in that the Belleville washer is juxtaposed with a flat washer on the side opposite the follower.

In one variant, the square according to the invention is also characterized in that the tapped part has, past the tapping, a cylindrical perforation extending axially to the end opposite the tapping.

In one variant, the square according to the invention is also characterized in that the elastic mechanism is a coil spring, supported on one side by a cap and on the other by a bolt, all of which is positioned in the perforation and coordinating with a slot on the threaded part.

The invention also relates to a method of assembling a square according to the invention, in which
one part is tapped and the other part is threaded,
both parts of the square are assembled end-to-end by screwing them together until they touch,

characterized in that
the tapped part is perforated axially, past the tapping, until it reaches the opposite end of the tapping,
the pitch and length of the threading and tapping is determined such that the longitudinal faces of the two parts of the square are coplanar relative to one another, at about five percent, when contact is made,
a washer is inserted between the two parts of the square,
the two parts of the square are positioned in a plane-parallel guide or in two aligned guides,
the bolt is inserted into the perforation,
the spring is used,
the cap is placed at the opposite end of the tapping, the cap having a milling,
the milling is set in the perforation,
the tapped part is pierced transversally, near the tapping, and a pin is inserted.

The invention and its various applications will be better understood upon reading the following description and studying the figures that accompany it. They are presented for illustrative purposes only and are not limiting to the invention.

The figures show:

FIG. 1, already described: a schematic representation of an example door handle system according to prior art;

FIG. 2, already described: a schematic representation of an example advanced door handle according to prior art;

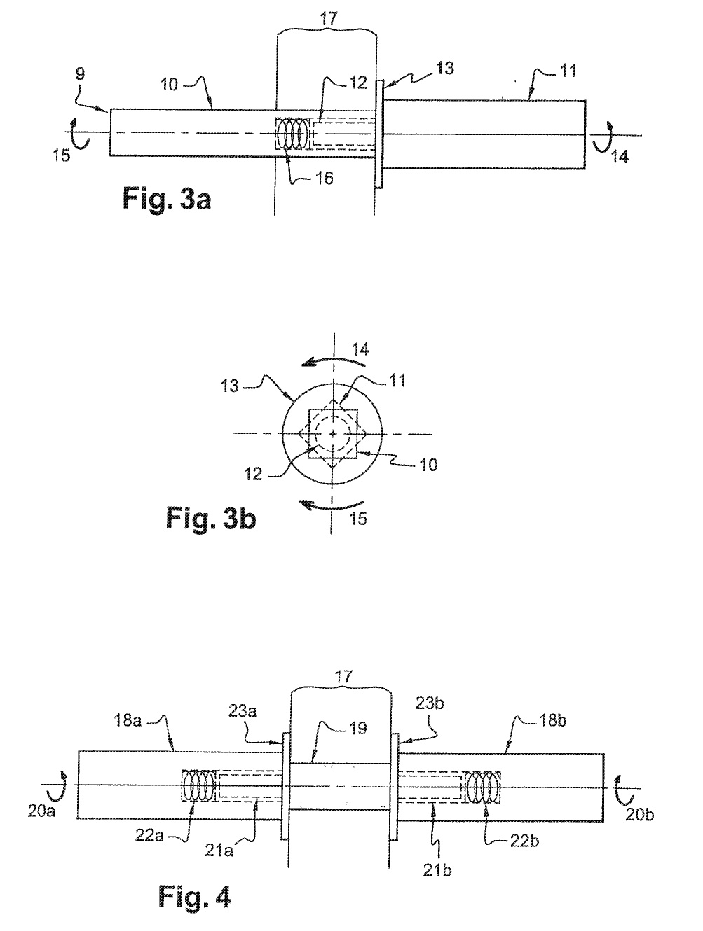

FIG. 3a: a profile view of a schematic representation of an example advanced handle square according to the invention in a locked position;

FIG. 3b: a front view of a schematic representation of the same example advanced handle square according to the invention in a locked position;

FIG. 4: a profile view of a schematic representation of another example advanced handle square according to the invention in a locked position;

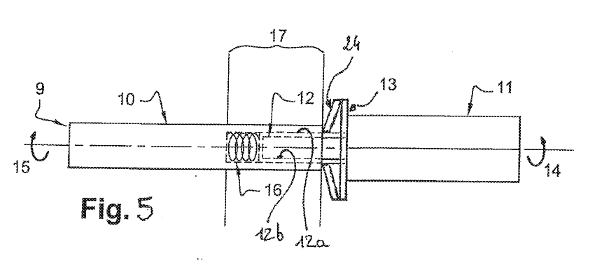

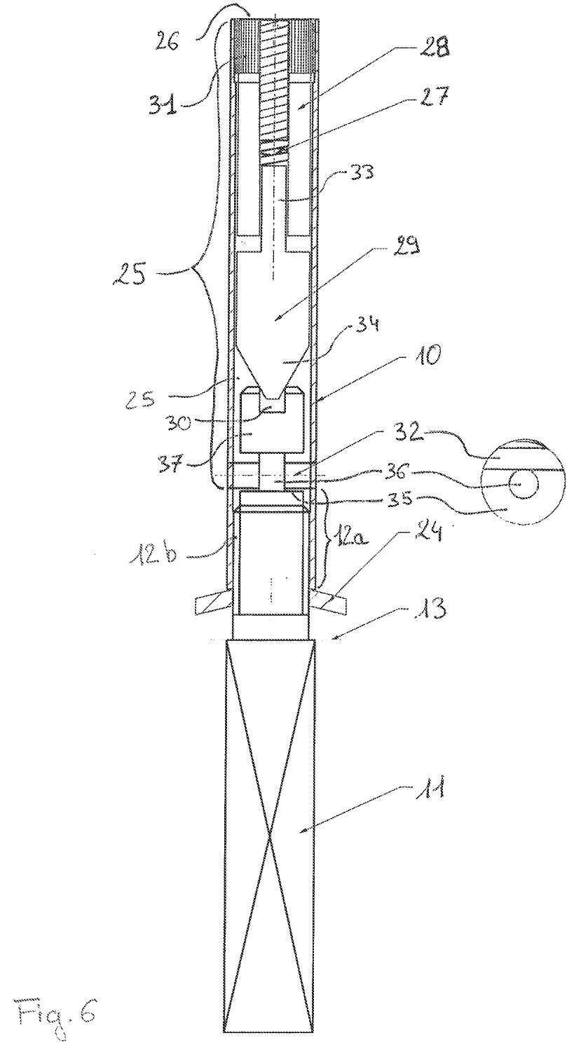

FIG. 5: a profile view of a schematic representation of another example of an advanced square assembly with two friction washers;

FIG. 6: a cross-section of a schematic representation of another example of an advanced square according to the invention.

FIG. 3a represents a profile view of an advanced door handle square according to the invention in a locked position.

The plane-parallel square 9 is comprised of two distinct parts 10 and 11 that are capable of coordinating with one another. The part 11 that is partially threaded by machining the material can be assembled by screwing it to the part 10 that is tapped at least as much. These two parts 10 and 11 are locked in relation to one another, in this embodiment of the square 9 according to the invention, by a movement of a user's left hand, resulting in a rotation of the lever handle in a direction 14 opposite an action of opening the opening and unlocked by a rotation in the direction 15 corresponding to an opening action but with an amplitude greater than that required for opening it.

When the square 9 is in position in a door, the part 10 that includes the tapping, whose length is greater than the part 11 that includes the threading, coordinates with the follower, i.e. the locking mechanism's hole for receiving said square. An action on a lever handle attached to the part 10 is directly transmitted to the locking mechanism. Conversely, an action on a lever handle attached to the part 11 is transmitted to the locking mechanism only if the parts 10 and 11 are mutually locked.

The locking by friction of the two parts 10 and 11 of the shaft to control the unlocking of the opening requires a force greater than that of a child. The two parts 10 and 11 of the shaft are assembled by screwing with a washer 13 between them, one side of said washer abutting the follower to prevent lateral movement of the square. This positioning requires that the thickness 17 of the door does not exceed the solid parts of the square 9. Thus, a user can always shorten and/or pierce the square 9 on either side.

The hardness of this washer 13 can determine the force required to lock/unlock the parts 10 and 11. In practice, this force should at least be greater than that required to open the opening by actuating a lever handle.

In a refinement, the two parts 10 and 11 of the shaft are assembled with multiple washers, some being elastic and Belleville washers. In this case, the Belleville washers act as a spring and thereby amplify the phenomenon of friction obtained by the screwing.

In one variant, the friction is obtained through screwing and tapping by the proper machining, such as conical machining.

In the invention, the prior art handle locking mechanism and return spring are deactivated.

The handle square 9 according to the invention has an elastic means, such as a spring 16 positioned at the bottom of the threading, so that the lever handle stays in a horizontal position when it is not in use.

The square 9 is made from an aluminum alloy between series 1000 and series 7000. Moreover, the mechanical properties of the square 9 are as follows:

24 daN/mm²≦Re≦100 daN/mm²

The mechanical properties of the washer 13 are as follows:

40≦Hv≦400, where Hv is the Vickers hardness.

The shaft 9 can present a section of between 5 and 10 millimeters. In this embodiment of the device according to the invention, the section of the shaft is seven millimeters.

The screw pitch is calculated such that the locking rotation 14 ends in a predetermined position. This predetermined position allows the effect of the spring 16 to be adjusted.

The length of the threaded and tapped part 12 represents at least 5% of the total length of the shaft 9.

FIG. 3b represents a front view of a door handle square according to the invention in the same lock position as in FIG. 3a.

In one variant, both parts of the square 9 are tapped, and a headless screw is used to penetrate each part 10 and 11 of the square 9. This screw is set in the tapping of the part 11 of the square 9 by a method that may be thermal, mechanical (such as crimping), or even chemical (such as by applying glue or thread lock).

The mechanical properties of such a screw are as follows:

240 N/mm²≦Re≦900 N/mm²; 95≦Hv≦320 where Hv is the Vickers hardness. Vickers hardness is measured with a standardized point of a square pyramid-shaped diamond whose apex formed by the sides is equal to 136°. The resulting impression thus has the shape of a square whose two diagonals d₁ and d₂ of the square are measured using an optical device. The value d is obtained by taking the average of d₁ and d₂. The value d will be used for the hardness calculation. The force and the length it is applied are also standardized. Hardness, written as Hv, is then read on a chart (a table) by the applied force. Hv is determined by the following equation:

$$\begin{matrix}Hv = Constant \times Test Load / Impression Area \\ = 0.102 \times 2 F \times sin ( 136 ° / 2 ) / {d}^{2} \\ = 0.189 \times F / {d}^{2}\end{matrix}$$

With d=(d2+d1)/2 d₁ and d₂ being the measurements of the impressions made at 90°, expressed in millimeters (two diagonals of the impression square); F, a test load, expressed in Newtons; g, the acceleration of gravity; and a constant equal to 1/g, or about 0.102.

In one variant, if there is no threading on the square 9, then it is beveled. The bevels are engaged by an action on the lever handle, like that described for locking the square 9. Once engaged, the bevels strengthen both parts of the box, allowing the secure side of the opening to be unlocked. Sufficient amplitude of the opening movement releases the bevels.

FIG. 4 represents a profile view of a schematic representation of another example advanced handle square according to the invention in a locked position. The square is then formed by three distinct coordinating parts 18a, 18b, and 19, with both 18a and 18b being the partially tapped 21a and 21b and 19 being duly tapped. The three parts 18a, 18b, and 19 can be locked in relation to one another by friction by turning the lever handle in the direction—20a for part 18a and 20b for part 18b—opposite of an opening action and unlocked by rotating the lever handle in the opening direction but with greater force than is required for opening it.

The length of the plane-parallel portion of the part 19 is approximately equal to the thickness 24 of the follower. Two washers 23a and 23b abut the follower to prevent the lateral movement of the square.

In the embodiment shown in FIG. 5, parts 10 and 11 of the square are both assembled together by means of two juxtaposed washers 13 and 24. The part 11, emerging from the opening 17, is threaded. It is engaged in the tapped part 12, which passes through the opening 17. The washer 24 is a Belleville, or cone-shaped, washer, and the other washer 13 is flat. The flat washer 13 is positioned on the side opposite the follower, touching the projection of the emerging part 11 where it extends by its threading 12b. The washer 24 is placed such that its base with the widest diameter touches the flat washer 13 and its base with the smallest diameter touches the apex of the pinned part 10 of the square.

In normal position, the lever handle, on the side of the opening secured by the invention, is free. Also in FIG. 5, note that the emerging part 11 of the square seems thicker than the part 10. It is actually the same size, but the profile view in FIG. 5 shows the part 11 from a diagonal because, in the diagram, the lever handle was moved 45°. It should be kept in a horizontal position, however, for aesthetic purposes. The freedom means that a traditional action on the lever handle is not transmitted to the opening's locking/unlocking mechanism and thus does not open the opening.

To open, the lever handle must first be lifted with a significant force and then lowered normally with a lesser force. The lifting has the effect of screwing the threading 12b into the tapping 12a. We find that, depending on the side of the opening being to be equipped, the pitch of the threading 12b and the tapping 12a must be direct or exact or reversed.

To return to the normal position, in which the lever handle is free, the opening movement must be continued beyond the movement needed for the opening and forced (with greater force than the lesser force) to disengage and unscrew the parts 10 and 11 of the square.

FIG. 6 schematically shows a sectional view of an embodiment of an advanced square according to the invention.

In this example, the torsion spring 16 is replaced by an elastic mechanism as described below. In normal position, the lever handle on the side secured by the invention is kept horizontal by the elastic mechanism.

Past the tapping 12a, the tapped part 10 has a cylindrical perforation 25 extending axially to the end 26 opposite the tapping 12a. The elastic mechanism has a coil spring 27, supported on one side by a cap 28. On the other side, the spring 27 is supported against a bolt 29. All of this is positioned in the perforation 25. The cap 28 has a milling 31 designed to be used in the perforation 25. More precisely, a shank 33 in the bolt 29 slides within the cap 28 and withstands pressure exerted by the spring 27. On the other side of the shank, the bolt 29 has a flat triangular head 34. The head 34 is formed by a dihedral that surrounds a circular cylinder. The end of the cylinder forms the flat end of a screwdriver. This flat end fits into a slot 30 machined into one end of the threaded part 11. The slot profile is perpendicular to a diameter of this threading 12b. The depth of the slot 30 is deployed based on this diameter. The flat end takes on the shape of the slot when the two parts 10 and 11 of the square are assembled. Any rotation of the lever handle located on the secure site makes the head 34 of the bolt 29 pivot and leave the slot 30. The level handle is held in a horizontal position when the bolt 29 is pushed into the slot 30, regardless of whether the part 11 is free or fixed.

The tapped part 10 is pierced transversally, near the end of the tapping 12a to accommodate a pin 32. For this purpose, the threaded part 11, see the detailed cross-section, is extended by a protuberance that has a base with an entablature 35, an intermediate post 36, and an anvil 37 in which the slot is formed 30. The protuberance is most narrow near the post 36. It has the shape of a circular cylinder. The pin 32, between the entablature 35 and the anvil 37, is capable of preventing the user from completely unscrewing the two parts 10 and 11 of the square, once the square is installed in a handle. By near, we mean a distance of a few millimeters, not exceeding two centimeters.

In a preferred embodiment of the square according to the invention, the various elements forming the square are made from a material like stainless steel 331.

A method for assembling a square according to the invention comprises steps in which, and not necessarily in this order,
the part 10 is tapped and the other part 11 is threaded,
the pitch and length of the threading 12b and tapping 12a is determined such that the longitudinal faces of the two parts 10 and 11 of the square are coplanar relative to one another, at about five percent, when contact is made between the two parts 10 and 11,
the tapped part 10 is perforated axially, past the tapping 12a, until it reaches the opposite end 26 of the tapping 12a,
a Belleville washer 24 and a flat washer 13 are inserted between the two parts 10 and 11 of the square, both washers being juxtaposed in the same manner as in FIG. 5,
both parts 10 and 11 of the square are assembled end-to-end by screwing them together until they touch,
the two parts 10 and 11 of the square are positioned in a plane-parallel guide or in two aligned guides,
the 29 bolt is inserted into the perforation 25,
the cap 28 is placed at the opposite end of the tapping 12, the cap 28 having a milling 31,
the milling 31 is set in the perforation 25,
the spring 27 is used,
the tapped part 10 is pierced transversally, near the tapping 12, and a pin 32 is inserted.

The fact that the longitudinal faces of the two parts 10 and 11 of the square are coplanar relative to one another, at about five percent, when contact is made between the two parts 10 and 11, allows the technician, who inserts the square into the guide, adjusts the alignment of the faces by exerting only a small rotation of one part 10 of the square with regard to the other 11.

In a preferred implementation of the method according to the invention, the various elements making up the square are carbonitrided.

1-19. (canceled)

20. An advanced handle square for a door, window, or an opening member, comprising:
two distinct parts coordinating with each other, a first part including threading and a second part including tapping;
wherein said square coordinates with a mechanical housing that contains a follower to actuate a bolt that controls a locking or unlocking to open or close the opening member, and coordinates with at least one lever handle actuated by a user;
wherein said square at least partially crosses the opening of the opening member and transfers a force to said housing;
wherein said two distinct parts are assembled by screwing with at least one washer between said two distinct parts, and locked in relation to each other by a friction from said two distinct parts on the washer;
wherein said friction is applied when the level handle is turned in a direction opposite to a direction to open the opening member; and
wherein said friction is released to provide an unlocking force to unlock the opening member by a rotational movement of the lever handle in the direction to open the opening member, said unlocking force being greater than a force required to open the opening member and exercised beyond the opening of the opening member.

21. An advanced handle square for a door, window, or an opening member, comprising:
three distinct parts coordinating with each other, two parts part including tapping and a third part includes double threading;
wherein said square coordinates with a mechanical housing that contains a follower to actuate a bolt that controls a locking or unlocking to open or close the opening member, and coordinates with at least one lever handle actuated by a user;
wherein said square at least partially crosses the opening and transfers a force to said housing;
wherein said three distinct parts are assembled by screwing with two washers between said three distinct parts, and locked in relation to each other by a friction from said three distinct parts on the washers;
wherein said friction is applied when the level handle is turned in a direction opposite to a direction to open the opening member; and
wherein said friction is released to provide an unlocking force to unlock the opening member by a rotational movement of the lever handle in the direction to open the opening member, said unlocking force being greater than a force required to open the opening member and exercised beyond the opening of the opening member.

22. The advanced handle square of claim 20, wherein said unlocking force to unlock the opening member requires a force and psychomotricity greater than that of a young child.

23. The advanced handle square of claim 20, wherein one side of the washer abuts a follower.

24. The advanced handle square of claim 20, wherein the washer is an elastic Belleville washer.

25. The advanced handle square of claim 20, wherein said second part coordinates with a follower and has length that is greater than said first part.

26. The advanced handle square of claim 20, wherein threading in said first part is obtained by machining material of said first part.

27. The advanced handle square of claim 20, wherein threading in said first part is obtained by screwing and by thermal, mechanical, or chemical fixing of a headless screw within a shortest part of said square.

28. The advanced handle square of claim 20, further comprising an elastic mechanism to allow the lever handle to rest in a horizontal position when it is not actuated.

29. The advanced handle square of claim 28, wherein said elastic mechanism is a torsion spring positioned at the bottom of the tapping and connecting said two distinct parts.

30. The advanced handle square of claim 20, wherein material of said square has the following mechanical features:
24 daN/mm²≦Re≦100 daN/mm² where Re is the material's elastic resistance.

31. The advanced handle square of claim 30, wherein said square is made from an aluminum alloy between series 1000 and series 7000.

32. The advanced handle square of claim 20, further comprising a section of between 5 and 10 millimeters.

33. The advanced handle square of claim 20, wherein a pitch of screw threading and tapping of said two distinct parts are predetermined such that said two distinct parts are locked in relation to each other in a predetermined position of the lever handle.

34. The advanced handle square of claim 20, wherein lengths length of the threading and tapping of said two distinct parts is at least 5% of a total length of said square and less than a thickness of the opening member.

35. The advanced handle square of claim 24, wherein said elastic Belleville washer is juxtaposed with a flat washer on the side opposite a follower.

36. The advanced handle square of claim 28, wherein said second part further includes a cylindrical perforation extending axially to the end opposite the tapping.

37. The advanced handle square of claim 36, wherein said elastic mechanism is a coil spring supported on one side by a cap and supported on the other side by a bolt, each of which is positioned in said cylindrical perforation of said second part and in coordination with a slot on the threading of said first part.

38. A method of assembling an advance handle square for a door, window or an opening member, said square comprising two distinct parts coordinating with each other, a first part including threading and a second part including tapping, said square coordinating with a mechanical housing that contains a follower to actuate a bolt that controls a locking or unlocking to open or close the opening member, said square coordinating with at least one lever handle actuated by a user, said square at least partially crossing the opening of the opening member and transfers a force to said housing, the method comprising the steps of:
axially perforating said second part, past the tapping, until a cylindrical perforation reaches an opposite end of the tapping;
determining pitch and length of the threading and tapping such that longitudinal faces of said two distinct parts of said square are coplanar relative to each other when contact is made between said two distinct parts;
inserting a washer between said two distinct parts of said square,
positioning said two distinct parts of said square in a plane-parallel guide or in two aligned guides;
inserting the bolt into said cylindrical perforation;
locating a spring in said cylindrical perforation;
locating a cap at the opposite end of the tapping, the cap having a milling which is set in said cylindrical perforation, said spring supported on one side by the cap and on other side by the bolt; and
transversally piercing said second part near the tapping and inserting a pin;
assembling said two distinct parts of said square end-to-end by screwing said two distinct parts together until said two distinct parts touch each other and are locked in relation to each other by a friction from said two distinct parts on the washer, such that said friction is applied when the level handle is turned in a direction opposite to a direction to open the opening member and said friction is released to provide an unlocking force to unlock the opening member by a rotational movement of the lever handle in the direction to open the opening member, said unlocking force being greater than a force required to open the opening member and exercised beyond the opening of the opening member.
